(19) United States
(12) Patent Application Publication
(10) Pub. No.: US 2019/0371180 A1
(43) Pub. Date: Dec. 5, 2019

(54) COMMUNICATION SYSTEM, ON-BOARD UNIT, AND COMMUNICATION METHOD

(71) Applicant: MITSUBISHI HEAVY INDUSTRIES MACHINERY SYSTEMS, LTD., Hyogo (JP)

(72) Inventors: Kenta HARA, Tokyo (JP); Rie HASEGAWA, Tokyo (JP)

(21) Appl. No.: 16/462,765

(22) PCT Filed: Nov. 30, 2016
(86) PCT No.: PCT/JP2016/085510

§ 371 Date: May 21, 2019

(51) Int. Cl. G08G 1/16; H04W 4/024; H04W 4/48; H04W 4/021; G08G 1/0968; G01C 21/34

(52) U.S. Cl. CPC G08G 1/164; H04W 4/024; H04W 4/48; G01C 21/3492; G08G 1/096827; G08G 1/096844; H04W 4/021

(57) ABSTRACT

A communication system, provided with: on-board units mounted on vehicles; a server; and a broker for mediating communication between a plurality of on-board units and between the on-board units and the server. The on-board units have a travel subject area specifying unit, a travel information generation unit for generating travel information, a message transmission unit for transmitting a message including the travel information, a message subscription unit for requesting a subscription for messages, and a guidance information generation unit for generating guidance information. The server has a travel information acquisition unit for requesting a subscription for messages including the travel information, a traffic information generation unit for generating traffic information, and a traffic information transmission unit for transmitting a message including the traffic information. The broker has a message distribution unit for distributing messages to the on-board units and the server.

### RELATED APPLICATIONS

The present application is a National Phase of International Application Number PCT/JP2016/085510 filed Nov. 30, 2016.

### Technical Field

The present invention relates to a communication system, an on-board unit, and a communication method.

### Background Art

As a system in which an on-board unit mounted on a vehicle transmits and receives information to and from other devices, for example, PTL 1 discloses a communication system in which a server collects vehicle information and the like acquired by an on-board unit, and transmits traffic information generated based on the collected vehicle information or the like within a predetermined time (for example, one hour) to the on-board unit through an intermediate server.

The server in such a communication system can generate highly accurate traffic information, based on vehicle information or the like collected from the plurality of on-board units. However, since the server cannot generate the highly accurate traffic information unless a lot of pieces of vehicle information or the like are collected, the frequency of updating the traffic information becomes low.

On the other hand, a communication system is known that performs transmission and reception of information requiring real-time property, using Vehicle to Vehicle (V2V) or the like performing short-range wireless communication between on-board units located in the vicinity. For example, in a communication system using V2V, an on-board unit directly communicates with another on-board unit mounted on a vehicle traveling in the vicinity, so it is possible to collect traveling information in real time such as the approach of vehicles to each other and the existence of a vehicle that has been suddenly braked.

### CITATION LIST

### Patent Literature

[PTL 1] Japanese Unexamined Patent Application Publication No. 2014-81872

### SUMMARY OF INVENTION

### Technical Problem

In the known communication system as described above, different communication methods are used in communication between the on-board unit and the server and communication between the on-board units. Therefore, the on-board unit needs to cope with a plurality of communication methods, which is a factor of increasing the development cost of the on-board unit.

The present invention has been made in view of such problems, and an object of the present invention is to provide a communication system, an on-board unit, and a communication method, capable of communicating between an on-board unit and a server and between on-board units, using a common communication method.

### Solution to Problem

According to a first aspect of the present invention, a communication system (1) includes an on-board unit (10) that is mounted on a vehicle; a server (30) that generates traffic information; and a broker (20) that mediates communication between a plurality of the on-board units and between the on-board unit and the server.

The on-board unit includes a travel target area specifying unit (110) that specifies a travel target area including at least one of a point at which the vehicle is traveling and a point at which the vehicle is scheduled to travel, among a plurality of areas obtained by dividing map into predetermined ranges; a traveling information generation unit (120) that generates traveling information including the point at which the vehicle is traveling; a message transmission unit (101) that among a plurality of topics prepared in advance for each of the plurality of areas, designates a topic indicating the travel target area, and transmits to the broker, the designated topic and a message including the traveling information in association with each other; a message subscription unit (102) that designates a topic indicating the travel target area and requests the broker to subscribe to a message associated with the topic; and a guidance information generation unit (130) that generates guidance information in the travel target area, based on a message delivered from the broker.

The server includes a traveling information acquisition unit (302) that requests the broker to subscribe to a message including the traveling information of the on-board unit; a traffic information generation unit (310) that generates traffic information for each area, based on the traveling information; and a traffic information transmission unit (301) that transmits to the broker, a message including the traffic information.

The broker includes a message delivery unit (202) that delivers a message received from the on-board unit and the server, to the on-board unit and the server that designate a topic associated with the message and request subscription.

With such a configuration, it is possible to transmit and receive messages associated with each area through the broker between the on-board unit and the server and between the on-board units. Thus, the on-board unit can transmit and receive messages using a common communication method, irrespective of whether the other party that transmits and receives a message is a server or another on-board unit. Therefore, it is possible to suppress an increase in development cost of the on-board unit by coping with a plurality of communication methods.

According to a second aspect of the present invention, in the communication system of the above aspect, the traffic information generation unit of the server generates, as the traffic information, dangerous area information indicating a dangerous area which is predicted to have a risk of collision of the vehicle, based on the traveling information.

When the travel target area is included in the dangerous area, the message subscription unit of the on-board unit designates a topic indicating the travel target area included in the dangerous area and requests the broker to subscribe to a message associated with the topic, the guidance information generation unit of the on-board unit generates, as the guidance information, first warning information indicating that a host vehicle is approaching the dangerous area, and the message transmission unit designates a topic indicating the travel target area, and transmits to the broker, the designated topic and a message including the first warning information in association with each other.

With such a configuration, when it is determined that the travel target area is included in the dangerous area, the on-board unit requests the broker to subscribe to the traveling information of another on-board unit traveling in the travel target area. Further, the guidance information generation unit of the on-board unit generates first warning information indicating that the host vehicle is approaching the dangerous area, and transmits a message including the first warning information in association with the topic indicating the travel target area, to the broker. Thus, the message associated with the topic is delivered to another vehicle present in the dangerous area, which makes it possible to reduce a risk that the vehicles collide with each other.

According to a third aspect of the present invention, in the communication system of the above-described aspect, the on-board unit further includes a failure information generation unit (150) that generates failure information indicating that a failure is likely to occur in the travel target area, based on at least one of the traveling information generated by the traveling information generation unit and the traveling information of another on-board unit. Further, the message transmission unit of the on-board unit designates a topic indicating the travel target area where the failure is likely to, and transmits to the broker, the topic and a message including the failure information in association with each other.

Since the server cannot generate highly accurate traffic information unless a lot of pieces of traveling information are collected from the on-board unit, there is a possibility that the frequency of updating the traffic information becomes low. However, the on-board unit according to the present aspect has the above-described configuration, so even when the server less frequently updates traffic information, and messages including traffic information are not delivered for a long period of time, it is possible to detect in real time that a failure is likely to occur in the travel target area.

According to a fourth aspect of the present invention, in the communication system of the above-described aspect, the guidance information generation unit of the on-board unit generates as the guidance information, second warning information indicating that a failure is likely to occur in the travel target area, based on the failure information generated by the failure information generation unit.

With such a configuration, the on-board unit can generate in real time second warning information indicating that a failure is likely to occur in the travel target area, based on the failure information generated by the failure information generation unit, even when the server less frequently updates traffic information, and messages including traffic information are not delivered for a long period of time. Thus, the on-board unit can alert the driver or the like of the vehicle before the vehicle reaches an area where a failure is likely to occur.

According to a fifth aspect of the present invention, in the communication system of the above-described aspect, the traffic information generation unit of the server generates, as the traffic information, congestion information for each area, based on the traveling information.

The guidance information generation unit of the on-board unit generates an alternative route including a point different from the point at which the vehicle is scheduled to travel as the guidance information, based on at least one of the failure information, the dangerous area information, and the congestion information.

With such a configuration, the guidance information generation unit of the on-board unit can generate an alternate route, based on the dangerous area information or congestion information generated by the server, and even in a state where the server less frequently updates the dangerous area information or the congestion information, and a message including the dangerous area information or the congestion information is not delivered for a long period of time, can generate an alternate route, based on the failure information.

According to a sixth aspect of the present invention, the on-board unit mounted on the vehicle includes a travel target area specifying unit that specifies a travel target area including at least one of a point at which the vehicle is traveling and a point at which the vehicle is scheduled to travel, among a plurality of areas obtained by dividing map into predetermined ranges; a traveling information generation unit that generates traveling information including the point at which the vehicle is traveling; a message transmission unit that among a plurality of topics prepared in advance for each of the plurality of areas, designates a topic indicating the travel target area, and transmits the designated topic and a message including the traveling information in association with each other, to a broker which mediates communication between the server and another on-board unit; a message subscription unit that designates a topic indicating the travel target area and requests the broker to subscribe to a message associated with the topic; and a guidance information generation unit that generates guidance information in the travel target area, based on a message delivered from the broker.

According to a seventh aspect of the present invention, there is provided a communication method using an on-board unit that is mounted on a vehicle, a server that generates traffic information, and a broker that mediates communication between a plurality of the on-board units and between the on-board unit and the server, the communication method including a traveling target area specifying step of specifying a traveling target area including at least one of a point at which the vehicle is traveling and a point at which the vehicle is scheduled to travel, among a plurality of areas obtained by dividing map into predetermined ranges, by the on-board unit; a traveling information generation step of generating traveling information including the point at which the vehicle is traveling, by the on-board unit; a message transmission step of, among a plurality of topics prepared in advance for each of the plurality of areas, designating a topic indicating the traveling target area, and transmitting to the broker, the designated topic and a message including the traveling information in association with each other, by the on-board unit; a message subscription step of designating a topic indicating the traveling target area and requesting the broker to subscribe to a message associated with the topic, by the on-board unit; a guidance information generation step of generating guidance information in the traveling target area, based on a message delivered from the broker, by the on-board unit; a traveling information acquisition step of requesting the broker to subscribe to a message including the traveling information of the on-board unit, by the server; a traffic information generation step of generating traffic information for each area, based on the traveling information, by the server; a traffic information transmission step of transmitting to the broker, a message including the traffic information, by the server; and a message delivery step of delivering a message received from the on-board unit and the server to the on-board unit and the server that designate a topic associated with the message and request subscription, by the broker.

### Advantageous Effects of Invention

According to the communication system, the on-board unit, and the communication method, described above, it is possible to perform communication between an on-board unit and a server and between on-board units, using a common communication method.

### BRIEF DESCRIPTION OF DRAWINGS

FIG. 1 is a diagram showing an overall configuration of a communication system according to a first embodiment of the present invention.

FIG. 2 is a diagram illustrating a functional configuration of an on-board unit according to the first embodiment of the present invention.

FIG. 3 is a diagram illustrating a functional configuration of a server according to the first embodiment of the present invention.

FIG. 4 is a diagram illustrating a functional configuration of a broker according to the first embodiment of the present invention.

FIG. 5 is a diagram for explaining functions of a communication system according to the first embodiment of the present invention.

FIG. 6 is a first processing flow of the on-board unit according to the first embodiment of the present invention.

FIG. 7 is a processing flow of the server according to the first embodiment of the present invention.

FIG. 8 is a second processing flow of the on-board unit according to the first embodiment of the present invention.

FIG. 9 is a diagram illustrating a functional configuration of an on-board unit according to a second embodiment of the present invention.

FIG. 10 is a first processing flow of the on-board unit according to the second embodiment of the present invention.

FIG. 11 is a second processing flow of the on-board unit according to the second embodiment of the present invention.

FIG. 12 is a diagram illustrating a functional configuration of an on-board unit according to a third embodiment of the present invention.

FIG. 13 is a diagram illustrating a functional configuration of a server according to the third embodiment of the present invention.

FIG. 14 is a processing flow of the on-board unit according to the third embodiment of the present invention.

FIG. 15 is a processing flow of the server according to the third embodiment of the present invention.

FIG. 16 shows a hardware configuration of the on-board unit according to each embodiment of the present invention.

### DESCRIPTION OF EMBODIMENTS

### First Embodiment

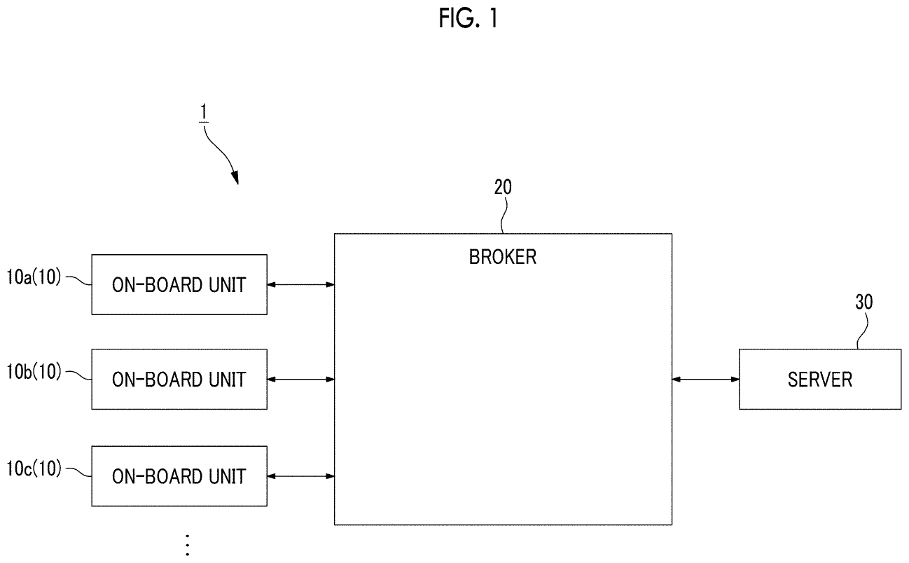

A communication system 1 according to a first embodiment of the present invention will be described below with reference to FIGS. 1 to 8.

### Overall Configuration of Communication System

FIG. 1 is a diagram showing an overall configuration of a communication system according to a first embodiment of the present invention.

In the present embodiment, the communication system 1 is, for example, a Publish/subscribe type communication system using protocol such as Message Queue Telemetry Transport (MQTT).

As shown in FIG. 1, the communication system 1 includes a plurality of on-board units 10a, 10b, 10c, . . . , a broker 20, and a server 30.

The on-board units 10a, 10b, 10c, . . . are mounted on the vehicles A1, A2, A3, . . . , respectively. In the following description, the plurality of on-board units 10a, 10b, 10c, . . . will also be collectively referred to as an on-board unit 10, and the plurality of vehicles A1, A2, A3, . . . will also be collectively referred to as a vehicle A.

The on-board unit 10 acquires traveling information on the vehicle A using a sensor (not shown), and transmits a message including the traveling information to the broker 20. Details of the traveling information will be described later.

The broker 20 is connectable to the on-board unit 10 by wireless communication. Further, the broker 20 is always connected to the server 30 by wired communication.

The broker 20 mediates transmission and reception of messages between the on-board units 10 (the on-board unit—the on-board unit), and transmission and reception of messages between the on-board unit 10 and the server 30 (the on-board unit—the server).

The server 30 generates traffic information based on the traveling information acquired from the on-board unit 10 through the broker 20 and transmits a message including the traffic information to the broker 20. Details of the traffic information will be described later.

In the communication system 1 of the present embodiment, the on-board unit 10 and the server 30 function as a publisher that transmits (issues) a message to the broker 20, and a subscriber (client) that receives (subscribes) a message from the broker 20 as well. Then, the broker 20 mediates transmission and reception of messages between the on-board unit 10 and the server 30, by collecting messages from the on-board unit 10 and the server 30, and delivering the collected messages to the on-board unit 10 and the server 30 that request subscription.

When transmitting the message to the broker 20 and requesting the broker 20 to subscribe to the message, the on-board unit 10 and the server 30 designate a topic and make a request for transmission and subscription of the message associated with the topic. The broker 20 collates the topic associated with the message with the topic designated at the time of requesting the subscription from the on-board unit 10 and the server 30, thereby specifying the on-board unit 10 and the server 30 as destinations of delivery of each message.

A topic indicates attributes of information included in a message, and one topic is designated for each message. For example, in the present embodiment, a plurality of topics are prepared in advance, for each of a plurality of areas obtained by dividing the map into predetermined ranges. Each of the plurality of areas may be obtained by dividing the map into roads, with an area from the start point to the end point of each road as a predetermined range, or may be obtained by dividing the map into rectangles at every predetermined distance (for example, 1 km).

Further, for example, a topic indicating “all areas” may be prepared as a topic of an upper level of topics indicating each area. When the server 30 designates the “all areas” topic for the broker 20 and requests subscription, the broker 20 delivers all the messages associated with the topic indicating any of the plurality of areas, to the server 30.

Further, topics indicating those other than areas may be prepared, for example, a topic indicating “all on-board units” may be prepared as a topic for delivering messages to all the on-board units 10.

The on-board unit 10 and the server 30 have map information capable of specifying each area and a topic list in which previously prepared topics are recorded, and designate a topic based on the map information and the topic list.

### Functional Configuration of On-Board Unit

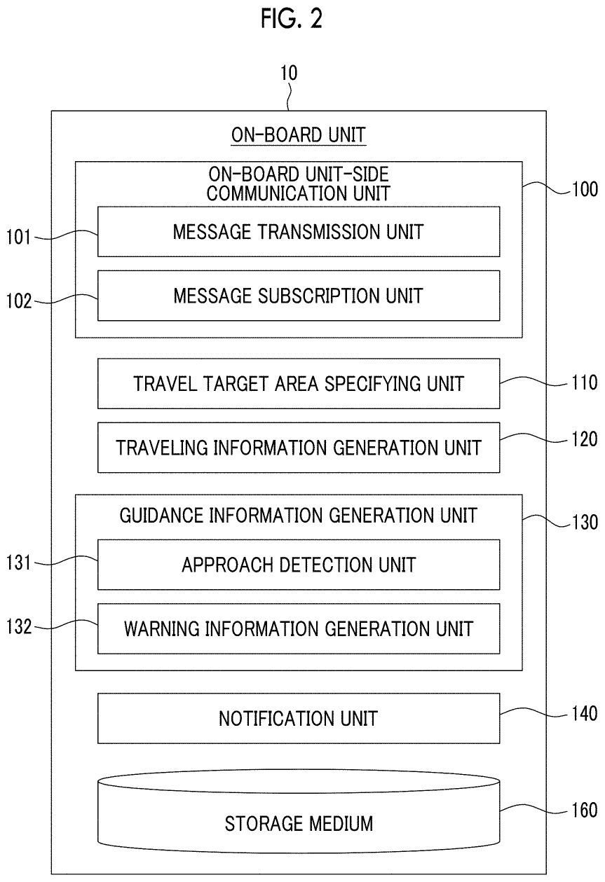

Hereinafter, the on-board unit 10 according to a first embodiment will be described with reference to FIG. 2.

FIG. 2 is a diagram illustrating a functional configuration of the on-board unit according to the first embodiment of the present invention.

As shown in FIG. 2, the on-board unit 10 includes an on-board unit-side communication unit 100, a travel target area specifying unit 110, a traveling information generation unit 120, a guidance information generation unit 130, a notification unit 140, and a storage medium 160.

The on-board unit-side communication unit 100 transmits and receives a message to and from the broker 20 through wireless communication. Further, the on-board unit-side communication unit 100 functions as an MQTT function unit that implements a function using the MQTT protocol.

The on-board unit-side communication unit 100 includes a message transmission unit 101 for transmitting a message to the broker 20, and a message subscription unit 102 for requesting the broker 20 to subscribe to a message.

The message transmission unit 101 designates the travel target area (described later) of the vehicle A on which the on-board unit 10 is mounted as a topic, and transmits the topic and the message including the traveling information of the vehicle A in association with each other to the broker 20.

The message subscription unit 102 designates the travel target area of the vehicle A on which the on-board unit 10 is mounted as a topic, and requests the broker 20 to subscribe to the message associated with the topic.

Further, the message subscription unit 102 designates a topic for which the on-board unit 10 requests a subscription and requests the broker 20 to subscribe to the message associated with the topic.

The travel target area specifying unit 110 specifies a travel target area indicating an area including at least one of a point at which the vehicle A provided with the on-board unit 10 is traveling and a point at which the vehicle A is scheduled to travel.

In the present embodiment, the travel target area includes a “current traveling area” indicating an area where the vehicle A is traveling and a “travel scheduled area” indicating an area where the vehicle A is scheduled to travel.

Specifically, the travel target area specifying unit 110 acquires the current position (latitude, longitude, and the like), which is the point where the vehicle A is traveling, by a sensor (not shown). Then, the area including the current position is extracted from the map information stored in advance in the storage medium 160 and specified as the “current traveling area”.

Further, the travel target area specifying unit 110 extracts an area including a point at which the vehicle A is scheduled to travel after current traveling area from map information, and specifies it as “travel scheduled area”, based on the traveling route indicating a combination of roads passing from the current position to the destination set in the on-board unit 10. Further, the travel target area specifying unit 110 may specify a plurality of “travel scheduled areas”. When the destination is not set, the travel target area specifying unit 110 further acquires the moving speed, the traveling direction, and the like of the vehicle A by a sensor (not shown). Then, the travel target area specifying unit 110 may predict the area where the vehicle A travels next to the current traveling area, based on the current position, the moving speed, and the traveling direction of the vehicle A, and specify the area as the “traveling scheduled area”.

The travel target area specifying unit 110 sequentially updates the current traveling area and the traveling scheduled area, based on the information such as the latest traveling information of the vehicle A, the destination, and the like.

The traveling information generation unit 120 acquires information such as the current position, moving speed, acceleration, and traveling direction of the vehicle A at predetermined intervals (for example, one second) by a sensor (not shown). The traveling information generation unit 120 generates traveling information including the acquired information. Then, the traveling information generation unit 120 designates a topic indicating the current traveling area (travel target area) specified by the travel target area specifying unit 110, and transmits to the broker 20, a message including the generated traveling information and a topic indicating the current traveling area (travel target area) in association with each other.

Further, in the present embodiment, an aspect has been described in which the traveling information generation unit 120 transmits to the broker 20, traveling information including the current position, moving speed, acceleration, and traveling direction of the vehicle A as a single message, but the present invention is not limited thereto. In another embodiment, the traveling information generation unit 120 may transmit each piece of information of the vehicle A as a different message to the broker 20. At this time, the traveling information generation unit 120 may hierarchize the topic as “current traveling area/current position” and “current traveling area/moving speed”, and transmit the topic indicating the contents of the current traveling area and the traveling information, and the message including the traveling information in association with each other to the broker 20.

The guidance information generation unit 130 generates guidance information in the travel target area, based on the message delivered from the broker 20.

In the present embodiment, guidance information generation unit 130 includes an approach detection unit 131 and a warning information generation unit 132.

The approach detection unit 131 determines whether or not the travel target area is included in the dangerous area, based on the traffic information included in the message delivered from the broker 20. Then, the approach detection unit 131 detects that the “current traveling area” is included in the dangerous area (the vehicle A is traveling in the dangerous area), or the “travel scheduled area” is included in the dangerous area (the vehicle A is approaching the dangerous area).

When the approach detection unit 131 detects that the vehicle A (host vehicle) is approaching the dangerous area or the vehicle A is traveling in the dangerous area, the warning information generation unit 132 generates warning information (first warning information) indicating that the vehicle A is approaching the dangerous area or the vehicle A is traveling in the dangerous area, as guidance information.

The warning information generation unit 132 transmits a message including the warning information and the topic indicating the travel target area in association with each other to the broker 20.

The warning information generation unit 132 outputs the warning information to the notification unit 140 as guidance information. At this time, the guidance information output to the notification unit 140 may be visual information such as a character string, an image, or the like, or audio information such as a buzzer or read warning information.

Further, when receiving a message including warning information from another vehicle, the warning information generation unit 132 may generate guidance information indicating that another vehicle is approaching the dangerous area or that the vehicle is traveling in a dangerous area and output it to the notification unit 140.

The notification unit 140 notifies the driver or the like of the vehicle A of the guidance information generated by the guidance information generation unit 130.

For example, the notification unit 140 has a display function such as a liquid crystal display (LCD) and an audio output function such as a speaker. The notification unit 140 outputs guidance information using at least one of the display function and the audio output function.

In the present embodiment, the notification unit 140 notifies the driver or the like of the vehicle A that the host vehicle is approaching the dangerous area or that the vehicle is traveling in a dangerous area, by outputting guidance information including the warning information generated by the warning information generation unit 132 using at least one of the display function and the audio output function. Further, when receiving a message including warning information from another vehicle, the notification unit 140 may notify that another vehicle is approaching the dangerous area or that the vehicle is traveling in a dangerous area.

The storage medium 160 stores traffic information delivered from the broker 20, traveling information of other vehicles, and the like.

The storage medium 160 also stores map information capable of specifying each area, and a topic list that records previously prepared topics.

### Functional Configuration of Server

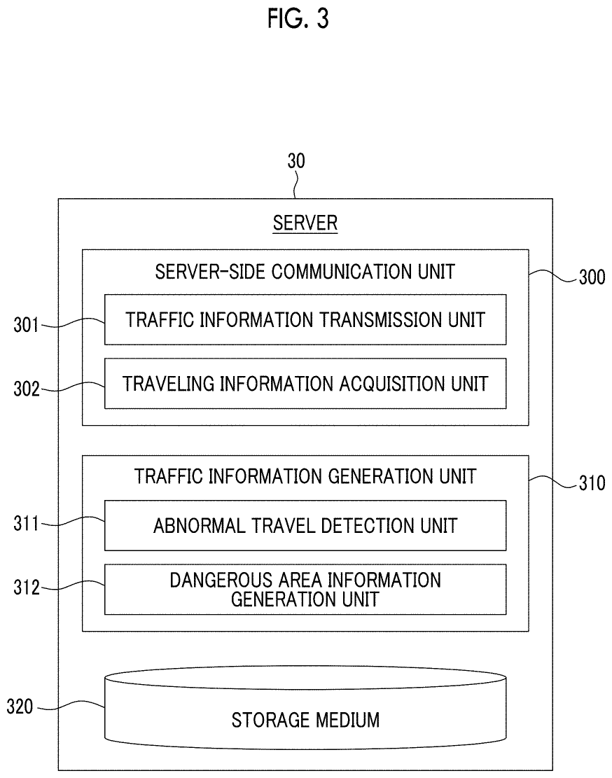

Hereinafter, the server 30 according to the first embodiment will be described with reference to FIG. 3.

FIG. 3 is a diagram illustrating a functional configuration of the server according to the first embodiment of the present invention.

As shown in FIG. 3, the server 30 includes a server-side communication unit 300, a traffic information generation unit 310, and a storage medium 320.

The server-side communication unit 300 transmits and receives a message to and from the broker 20 through wired communication. Further, the server-side communication unit 300 functions as an MQTT function unit that implements a function using the MQTT protocol.

The server-side communication unit 300 includes a traffic information transmission unit 301 that transmits a message including traffic information to the broker 20, and a traveling information acquisition unit 302 that requests the broker 20 to subscribe to the message including traveling information of the on-board unit 10.

The traffic information transmission unit 301 transmits to the broker 20, a message including traffic information for each area generated by the traffic information generation unit 310 described later.

The traveling information acquisition unit 302 designates a topic for which the server 30 requests a subscription and requests the broker 20 to subscribe to the message associated with the topic. In the present embodiment, the traveling information acquisition unit 302 designates a topic indicating “all areas” and requests the broker 20 to subscribe to the message, thereby acquiring a message including traveling information of the on-board unit 10 located in each area. Thus, the traveling information acquisition unit 302 collects traveling information of the on-board unit 10 in all the areas. In addition, the traveling information acquisition unit 302 may designate a topic indicating one of a plurality of areas and request a message subscription for each area.

The traffic information generation unit 310 generates traffic information, based on traveling information collected from the plurality of on-board units 10 through the broker 20. In the present embodiment, the traffic information generation unit 310 generates as traffic information, dangerous area information indicating an area which is predicted to have a risk of collision of the vehicle.

The traffic information generation unit 310 includes an abnormal travel detection unit 311 and a dangerous area information generation unit 312.

The abnormal travel detection unit 311 detects abnormal travel of the vehicle A on which the on-board unit 10 is mounted, based on traveling information collected from the plurality of on-board units 10 through the broker 20. The abnormal travel indicates, for example, that the vehicle A has performed an operation such as a sudden braking or a sudden steering wheel operation while it is traveling.

Specifically, the abnormal travel detection unit 311 detects that the vehicle A associated with the traveling information travels abnormally, based on the current position, the moving speed, the acceleration, and the traveling direction included in the traveling information, and specifies the area where the abnormal travel is detected.

For example, when the acceleration (the acceleration in the traveling direction) included in the traveling information of the vehicle A is lower than the reference value, the abnormal travel detection unit 311 detects that the vehicle A performs a sudden braking. Further, for example, when the traveling direction included in the traveling information of the vehicle A indicates a direction different from the extending direction of the road where the vehicle A is located, or when the acceleration (acceleration corresponding to the turning motion) exceeds the reference value, the abnormal travel detection unit 311 detects that the vehicle A performs a sudden steering wheel operation.

Upon detecting that the abnormal travel is performed, the abnormal travel detection unit 311 specifies the area in which the abnormal travel is detected, based on the topic designated in the message including the traveling information. Further, the abnormal travel detection unit 311 may specify a point (latitude, longitude) at which abnormal travel is detected, based on the current position included in the traveling information.

The dangerous area information generation unit 312 specifies an area where the abnormal travel is performed at a high frequency, based on the detection result of the abnormal travel by the abnormal travel detection unit 311.

Specifically, the dangerous area information generation unit 312 determines whether or not the frequency of abnormal travel in the area is high, based on the area in which the abnormal travel detection unit 311 has detected the abnormal travel within the predetermined collecting period and the number of cases in which the abnormal travel is detected within the predetermined collecting period. When the number of abnormal travels in a certain area is equal to or more than a predetermined number (for example, five), the dangerous area information generation unit 312 determines that the frequency of abnormal travel is high in the area. Then, the dangerous area information generation unit 312 predicts that there is a risk of collision of the vehicle in an area where the frequency of abnormal travel is high, and generates dangerous area information indicating that the area is a dangerous area, as traffic information.

When the abnormal travel is no longer detected in the area for which the dangerous area information was generated in the past, the dangerous area information generation unit 312 may generate dangerous area information indicating that the area is no longer a dangerous area.

In this way, the dangerous area information generation unit 312 generates and updates the dangerous area information each time a predetermined collection period elapses. Then, the dangerous area information generation unit 312 designates a topic indicating “all on-board units” such that a message including dangerous area information is delivered to all the on-board units 10, and transmits a message including the generated dangerous area information to the broker 20 through the traffic information transmission unit 301.

The storage medium 320 stores traveling information of a plurality of on-board units 10, delivered from the broker 20.

The storage medium 320 also stores map information capable of specifying each area, and a topic list that records previously prepared topics.

### Functional Configuration of Broker

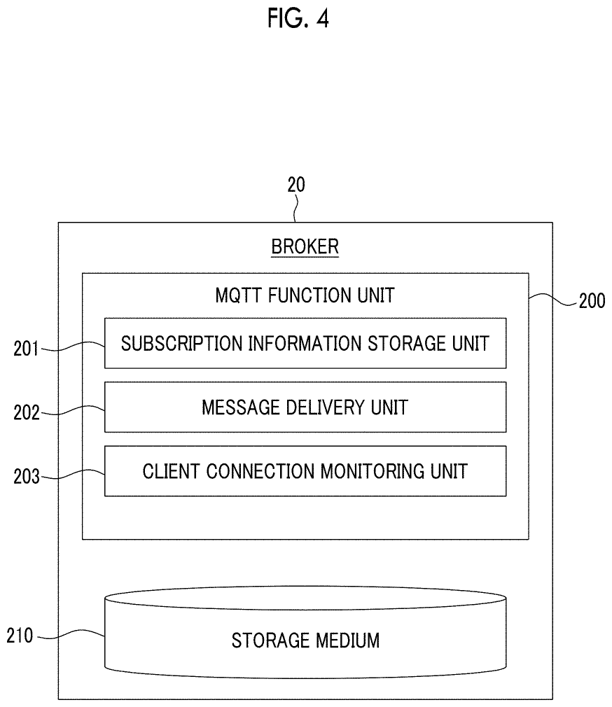

Hereinafter, the broker 20 according to the first embodiment will be described with reference to FIG. 4.

FIG. 4 is a diagram illustrating a functional configuration of the broker according to the first embodiment of the present invention.

As shown in FIG. 4, the broker 20 includes an MQTT function unit 200 and a storage medium 210.

The MQTT function unit 200 transmits and receives messages to and from the on-board unit 10 through wireless communication, and transmits and receives messages to and from the server 30 through wired communication.

The MQTT function unit 200 includes a subscription information storage unit 201, a message delivery unit 202, and a client connection monitoring unit 203.

The subscription information storage unit 201 stores subscription information in which the topic designated in the subscription request from the message subscription unit 102 of the on-board unit 10 and the client ID specifying the on-board unit 10 are associated with each other in the storage medium 210.

Further, the subscription information storage unit 201 stores subscription information in which the topic designated in the subscription request from the traveling information acquisition unit 302 of the server 30 and the client ID specifying the server 30 are associated with each other in the storage medium 210.

In this manner, the subscription information storage unit 201 stores topics requested to be subscribed from each of the plurality of on-board units 10 and the server 30, as subscription information, for each device.

Based on the subscription information stored in the storage medium 210, the message delivery unit 202 delivers messages transmitted from the on-board unit 10 and the server 30, to the on-board unit 10 and the server 30, which are destinations requesting the subscription of the message. The message delivery unit 202 searches for and extracts the delivery destination requesting subscription of each message, from the subscription information, with the topic designated in each message as a key. Then, the message delivery unit 202 delivers the message associated with the topic to the extracted delivery destination.

When wireless communication with the on-board unit 10 requesting subscription of the message is disconnected, the message delivery unit 202 stores and accumulates a message for the topic for which the on-board unit 10 is requesting subscription, in the storage medium 210. When the wireless communication with the on-board unit 10 is reconnected, the message delivery unit 202 reads out the accumulated messages from the storage medium 210 and delivers the messages in a batch.

The client connection monitoring unit 203 monitors whether communication with the on-board unit 10 and the server 30 is normally established or not. In the present embodiment, since it is always connected with the server by wired communication, the client connection monitoring unit 203 may monitor only whether or not wireless communication with the on-board unit 10 is normally established.

In the storage medium 210, messages transmitted from the on-board unit 10 and the server 30 are stored, and subscription information for each device is stored.

### Processing Flow of Communication System

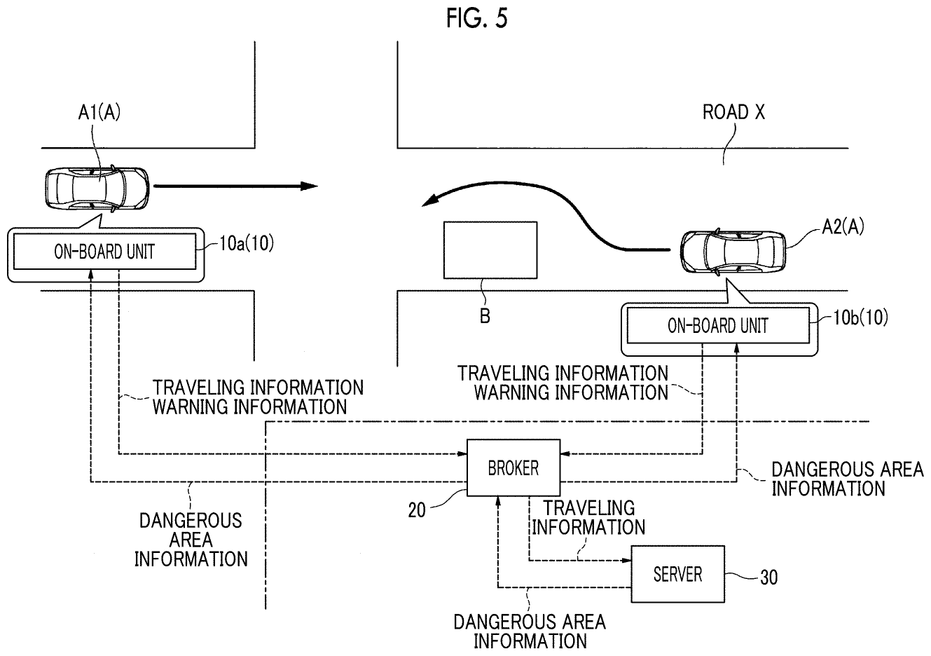

Hereinafter, the processing flow of the communication system 1 according to the first embodiment of the present invention will be described with reference to FIGS. 5 to 8.

FIG. 5 is a diagram for explaining functions of the communication system according to the first embodiment of the present invention.

In the example of FIG. 5, both the vehicle A1 on which the on-board unit 10a is mounted and the vehicle A2 on which the on-board unit 10b is mounted travel on the road X. It is also assumed that there is an obstacle B on the road X, and a plurality of vehicles are traveling so as to avoid the obstacle B. A flow of the process of the communication system 1 according to the present embodiment will be described with such a situation as an example.

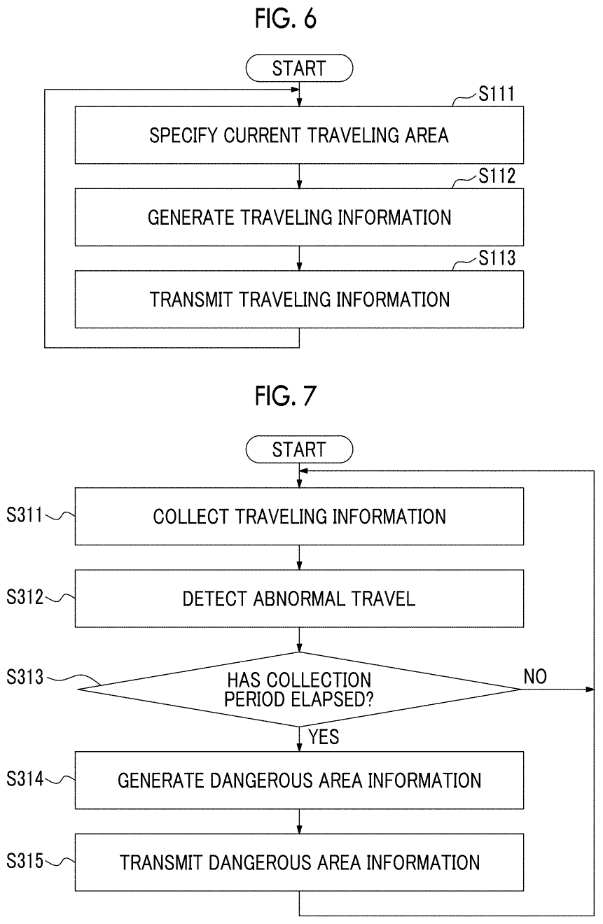

FIG. 6 is a first processing flow of the on-board unit according to the first embodiment of the present invention.

Hereinafter, with reference to FIG. 6, a process in which the on-board unit 10 transmits traveling information will be described.

First, the travel target area specifying unit 110 detects a point at which the vehicle A provided with the on-board unit 10 is traveling by a sensor (not shown). Then, the travel target area specifying unit 110 specifies the “current traveling area” indicating the area including a point at which the vehicle is traveling, based on the map information stored in the storage medium 160 (step S111).

For example, the on-board unit 10a shown in FIG. 5 specifies “road X” which is an area including a point at which the vehicle is traveling as “current traveling area”.

Next, the traveling information generation unit 120 acquires information such as the current position, moving speed, acceleration, and traveling direction of the vehicle A at predetermined intervals (for example, one second) by a sensor (not shown). Then, the traveling information generation unit 120 generates traveling information including each piece of acquired information (step S112).

Next, the traveling information generation unit 120 designates a topic indicating the current traveling area (road X) specified by the travel target area specifying unit 110, and transmits a topic indicating the traveling area and a message including the generated traveling information in association with each other to the broker 20 (step S113).

In this way, the on-board unit 10 repeatedly executes the processing of steps S111 to S113 at predetermined intervals.

FIG. 7 is a processing flow of the server according to the first embodiment of the present invention.

Hereinafter, a process in which the server 30 generates and transmits dangerous area information as traffic information will be described with reference to FIG. 7.

First, the traveling information acquisition unit 302 designates a topic indicating “all areas”, and requests the broker 20 to subscribe messages related to each area. Then, the traveling information acquisition unit 302 collects traveling information of the on-board unit 10 in each area, based on the message delivered from the broker 20 and the topic associated with the message (step S311).

Next, the abnormal travel detection unit 311 detects abnormal travel of the vehicle A, based on the traveling information collected by the traveling information acquisition unit 302 (step S312).

For example, as shown in FIG. 5, when there is an obstacle B on the road X, the vehicle A2 traveling in the vicinity of the obstacle B is supposed to decelerate (sudden braking) in front of the obstacle B and perform operations such as changing the direction of travel (sudden steering wheel) so as to avoid the obstacle B. The abnormal travel detection unit 311 detects that a sudden braking, a sudden steering wheel operation, or the like has been performed, based on the current position, the moving speed, the acceleration, and the traveling direction included in the traveling information.

Specifically, when the acceleration (the acceleration in the traveling direction) exceeds the reference value, the abnormal travel detection unit 311 detects that a sudden braking (abnormal travel) has been performed.

Further, when the traveling direction indicates a direction different from the extending direction of the road X, that is, when the angle between the imaginary line extending in the traveling direction of the vehicle and the road X is equal to or larger than a predetermined angle, the abnormal travel detection unit 311 detects that a sudden steering wheel operation (abnormal travel) has been performed. Further, when the acceleration (the acceleration corresponding to the turning motion) exceeds the reference value, the abnormal travel detection unit 311 may detect that a sudden steering wheel operation (abnormal travel) has been performed.

Further, the abnormal travel detection unit 311 specifies an area in which abnormal travel is detected, based on a topic associated with a message including traveling information. Further, the abnormal travel detection unit 311 may specify a point (latitude, longitude) at which abnormal travel such as a sudden braking, a sudden steering wheel operation, or the like is detected, based on the current position of the vehicle A included in the traveling information.

Next, the dangerous area information generation unit 312 determines whether or not a predetermined collection period (for example, 30 minutes) has elapsed (step S313).

When the collection period has not elapsed (step S313: NO), the dangerous area information generation unit 312 waits until the collection period has elapsed. Meanwhile, the server 30 returns to step S311 and repeats the above process.

On the other hand, when the collection period has elapsed (step S313: YES), the dangerous area information generation unit 312 proceeds to the next step S314.

Next, the dangerous area information generation unit 312 generates dangerous area information indicating a dangerous area having a high frequency of abnormal travel, based on the detection result of the abnormal travel by the abnormal travel detection unit 311 (step S314).

Specifically, when abnormal travel of more than a predetermined number (for example, five) is detected in a certain area (road X), the dangerous area information generation unit 312 determines that the frequency of abnormal travel of the road X is high. Then, the dangerous area information generation unit 312 predicts that there is a risk of collision of the vehicle on the road X, and generates dangerous area information indicating that the road X is a dangerous area as traffic information.

In addition, the dangerous area information generation unit 312 may further divide each area into a plurality of zones, and determine a zone of each area where the abnormal travel frequently occurs. For example, the dangerous area information generation unit 312 specifies the zone in which the abnormal travel is detected, based on the point where the abnormal travel detection unit 311 detects the abnormal travel. Then, when the number of abnormal travels in at least one zone among a plurality of zones is a predetermined number or more, the dangerous area information generation unit 312 may generate dangerous area information indicating that an area including the zone is a dangerous area. In this case, the dangerous area information generation unit 312 may include information indicating a zone in which the frequency of abnormal travel is high in the dangerous area information.

Next, when generating the dangerous area information indicating that the road X is a dangerous area, the dangerous area information generation unit 312 designates a topic indicating “all on-board units” and transmits a message including dangerous area information to the broker 20 through the traffic information transmission unit 301 (step S315).

In this manner, the server 30 repeatedly executes the processing of the above-described steps S311 to S315, thereby generating (updating) and transmitting the dangerous area information.

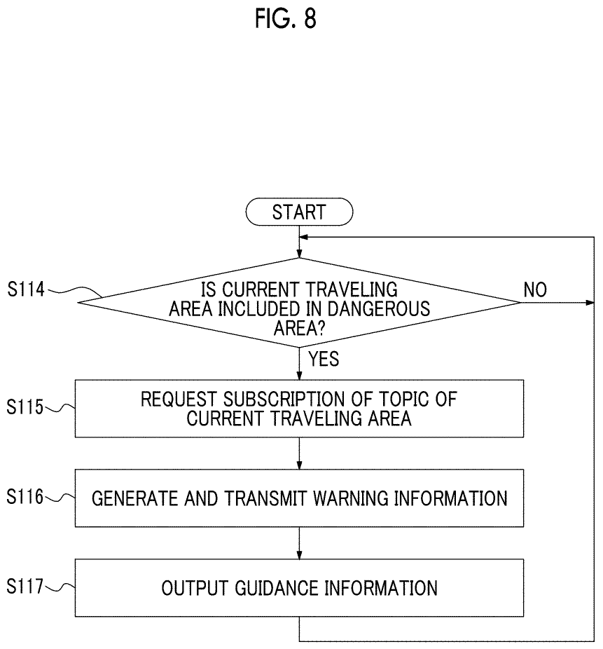

FIG. 8 is a second processing flow of the on-board unit according to the first embodiment of the present invention.

Hereinafter, with reference to FIG. 8, a process in which the on-board unit 10 issues a warning of approaching a dangerous area will be described. In the following example, when wireless communication with the broker 20 is established, in order to subscribe to messages issued for all on-board unit 10, the message subscription unit 102 of the on-board unit 10 designates the topic indicating “all on-board units”, and requests the broker 20 to subscribe to the message associated with the topic of “all on-board units”. Then, it is assumed that a message including the dangerous area information generated by the server 30 is delivered to each on-board unit 10 by the broker 20.

First, the approach detection unit 131 determines whether or not the current traveling area is included in the dangerous area, based on the dangerous area information included in the message delivered from the broker 20 (step S114).

When the information indicating that the current traveling area is the dangerous area is not included in the dangerous area information, the approach detection unit 131 determines that the current traveling area is not included in the dangerous area (step S114: NO). In this case, the approach detection unit 131 returns to the beginning of the process. When determining that the current traveling area is not included in the dangerous area, the approach detection unit 131 may wait until the current traveling area or the dangerous area information is updated without performing the processing of step S114.

On the other hand, as in the examples of FIGS. 5 and 7, when the dangerous area information indicating that the road X is a dangerous area is generated by the dangerous area information generation unit 312 of the server 30 (steps S314 and S315 in FIG. 7), a message including the dangerous area information is delivered to the on-board unit 10. Therefore, the approach detection unit 131 determines that the current traveling area (road X) is included in the dangerous area, based on the dangerous area information (step S114: YES). In this case, the approach detection unit 131 proceeds to the next step S115.

In addition, the approach detection unit 131 may determine whether the travel scheduled area is included in the dangerous area, based on the dangerous area information.

Next, when the approach detection unit 131 determines that the current traveling area is included in the dangerous area (step S114: YES), the message subscription unit 102 designates the current traveling area as a topic and requests the broker 20 to subscribe to the message associated with the topic indicating the current traveling area (step S115).

For example, in the example of FIG. 5, the approach detection unit 131 determines that the road X that is the current traveling area is included in the dangerous area. Therefore, the message subscription unit 102 designates the road X which is the current travel area as a topic, and requests the broker 20 to subscribe to the message associated with the road X.

When acquiring the dangerous area information indicating that the road X which is the current traveling area is no longer a dangerous area, the message subscription unit 102 requests the broker 20 to release the subscription of the message associated with the road X.

Next, the warning information generation unit 132 of the on-board unit 10a generates warning information (first warning information) indicating that the vehicle A1 (host vehicle) is approaching the dangerous area or that the vehicle A is traveling in the dangerous area. The warning information generation unit 132 transmits a message including the generated warning information and the topic indicating the travel target area in association with each other to the broker 20, through the message transmission unit 101 (step S116).

Next, the warning information generation unit 132 of the on-board unit 10a outputs warning information indicating that the host vehicle A1 is approaching the dangerous area or is traveling in the dangerous area to the notification unit 140 as the guidance information (step S117). The notification unit 140 notifies the driver of the vehicle A1 of the guidance information so as to warn that the host vehicle A1 is approaching the dangerous area or traveling in a dangerous area and that attention is required for traveling.

Further, when receiving a message including warning information from another vehicle A2, the warning information generation unit 132 may generate guidance information indicating that another vehicle A2 is approaching the dangerous area or that the vehicle is traveling in a dangerous area and output it to the notification unit 140. The notification unit 140 also notifies the driver of the vehicle A1 of the guidance information when receiving such guidance information.

Even in the on-board unit 10b, the above-described processing is also executed, and a warning is issued to the driver or the like of the vehicle A2.

In this way, the on-board unit 10 repeatedly executes the processing of the above-described steps S114 to S117.

### Function and Effect

As described above, the communication system 1 according to the present embodiment includes an on-board unit 10 that is mounted on a vehicle A; a server 30 that generates traffic information; and a broker 20 that mediates communication between a plurality of the on-board units 10, and between the on-board unit 10 and the server 30.

The on-board unit 10 includes a travel target area specifying unit 110 that specifies as a travel target area, at least one of a current traveling area including a point at which the vehicle A is traveling and a travel scheduled area including a point at which the vehicle is scheduled to travel, among a plurality of areas obtained by dividing a map into predetermined ranges; a traveling information generation unit 120 that generates traveling information including at least one of a current position of the vehicle A (the point at which the vehicle A is traveling), a moving speed, an acceleration, and a traveling direction; a message transmission unit 101 that designates a topic indicating the travel target area, and transmits to the broker 20, the topic and a message including traveling information in association with each other; a message subscription unit 102 that designates a topic indicating the travel target area and requests the broker 20 to subscribe to a message associated with the topic; and a guidance information generation unit 130 that generates guidance information in the current traveling area, based the traveling information generated by the traveling information generation unit 120 and the message subscribed by the message subscription unit 102.

The server 30 includes a traveling information acquisition unit 302 that request the broker 20 to subscribe to a message including the traveling information; a traffic information generation unit 310 that generates dangerous area information, based on the traveling information; and a traffic information transmission unit 301 that transmits to the broker 20, a message including the dangerous area information.

The broker 20 includes a message delivery unit 202 that delivers a message received from the on-board unit 10 and the server 30, to the on-board unit 10 and the server 30 that designate a topic associated with the message and request subscription.

With such a configuration, it is possible to transmit and receive messages associated with each area through the broker 20 between the on-board unit 10 and the server 30 or between the on-board units 10. Thus, the on-board unit 10 can transmit and receive messages using a common communication method, irrespective of whether the other party that transmits and receives a message is the server 30 or another on-board unit 10. Therefore, it is possible to suppress an increase in development cost of the on-board unit 10 by coping with a plurality of communication methods.

In addition, the dangerous area information generation unit 312 of the server 30 generates, as traffic information, dangerous area information indicating a dangerous area which is predicted to have a risk of collision of the vehicle A, based on traveling information.

When the current traveling area (the travel target area) is included in the dangerous area, the message subscription unit 102 of the on-board unit 10 designates a topic indicating the current traveling area included in the dangerous area, and requests the broker 20 to subscribe to a message associated with the topic. The warning information generation unit 132 of the on-board unit 10 generates as the guidance information, warning information (first warning information) indicating that a host vehicle is traveling in a dangerous area. Further, the message transmission unit 101 of the on-board unit 10 designates a topic indicating the travel target area, and transmits to the broker 20, the designated topic and a message including the first warning information in association with each other.

With such a configuration, when it is determined that the current traveling area is included in the dangerous area, the message subscription unit 102 acquires (subscribes to) traveling information of another on-board unit 10 traveling in the current traveling area through the broker 20. Further, the warning information generation unit 132 generates first warning information indicating that the host vehicle is traveling in the dangerous area, and transmits a message including the first warning information in association with the topic indicating the current traveling area, to the broker 20, through the message transmission unit 101. Thus, the message including the first warning information is delivered to another vehicle present in the dangerous area, which makes it possible to reduce the risk that the vehicles collide with each other. Further, the warning information generation unit 132 notifies the driver or the like of the vehicle A of the guidance information including the generated warning information through the notification unit 140, thereby causing the driver or the like to recognize that the vehicle is traveling in the dangerous area, which makes it possible to reduce the risk that the vehicles A collide with each other.

### Second Embodiment

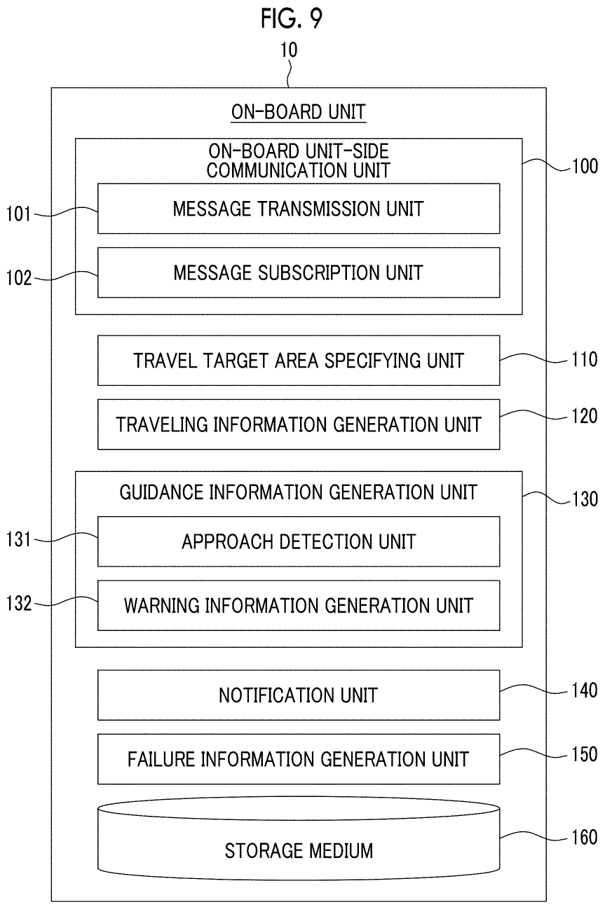

Hereinafter, a communication system 1 according to a second embodiment of the present invention will be described with reference to FIGS. 9 to 11.

Constituent elements common to those of the first embodiment are denoted by the same reference numerals, and a detailed description thereof is omitted.

### Functional Configuration of Vehicle-Mounted Device

FIG. 9 is a diagram illustrating a functional configuration of an on-board unit according to a second embodiment of the present invention.

As shown in FIG. 9, the on-board unit 10 according to the present embodiment is different from the first embodiment in that it further includes a failure information generation unit 150.

In the first embodiment, when the approach detection unit 131 determines that the current traveling area is included in the dangerous area, the message subscription unit 102 of the on-board unit 10 designates the current traveling area as a topic and requests the broker 20 to subscribe to the message associated with the topic (step S115 in FIG. 8). However, regardless of whether the current traveling area is included in the dangerous area or not, the message subscription unit 102 of the on-board unit 10 according to the present embodiment designates each of the current traveling area and the travel scheduled area as a topic, and requests the broker 20 to subscribe to messages associated with each topic. Therefore, the message subscription unit 102 requests the broker 20 to subscribe the message every time when the communication between the on-board unit 10 and the broker is established and when the travel target area is updated.

The failure information generation unit 150 generates failure information indicating that a failure has occurred in the travel target area, based on at least one of the traveling information generated by the traveling information generation unit 120 and the traveling information of another on-board unit 10 included in the message delivered from the broker 20.

Incidentally, the failure indicates an event for delaying the traveling of the vehicle A, and an event requiring an operation of a sudden braking, a sudden steering wheel operation, or the like, and is, for example, an obstacle on the road, congestion, an accident or the like.

### Processing Flow of Vehicle-Mounted Device

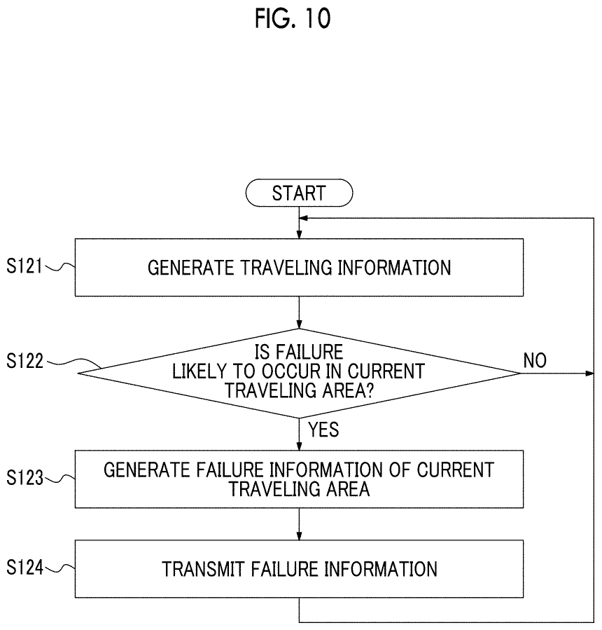

FIG. 10 is a first processing flow of the on-board unit according to the second embodiment of the present invention.

Hereinafter, a process in which the failure information generation unit 150 of the on-board unit 10 generates failure information based on the traveling information generated by the traveling information generation unit 120 will be described.

First, the traveling information generation unit 120 acquires the current position, moving speed, acceleration, and traveling direction of the vehicle A at predetermined intervals (for example, one second) by a sensor (not shown), and generates traveling information (step S121).

Next, the failure information generation unit 150 determines whether a failure is likely to occur in the current traveling area, based on the latest traveling information generated by the traveling information generation unit 120 (step S122).

Specifically, the failure information generation unit 150 determines whether a failure is likely to occur, based on the current position, the moving speed, the acceleration, and the traveling direction included in the traveling information. For example, when the acceleration (the acceleration of the vehicle A in the traveling direction) included in the traveling information is lower than the reference value, the failure information generation unit 150 determines that a failure requiring a sudden braking is likely to occur. Further, for example, when the traveling direction included in the traveling information indicates a direction different from the extending direction of the road where the vehicle A is located, or when the acceleration (acceleration corresponding to the turning motion) exceeds the reference value, the failure information generation unit 150 determines that a failure requiring a sudden steering wheel operation is likely to occur. Further, for example, when the moving speed included in the traveling information is less than the predetermined congestion determining speed, the failure information generation unit 150 determines that a failure such as congestion is likely to occur in the current position of the vehicle A. Further, the congestion determining speed is set in advance for each road based on the limit speed or the like, in the map information stored in the storage medium 160.

When the failure information generation unit 150 determines that a failure is likely to occur in the current traveling area (step S122: YES), the process proceeds to the next step S123.

On the other hand, when the failure information generation unit 150 determines that a failure is not likely to occur in the current traveling area (step S122: NO), the on-board unit 10 returns to step S121 and repeats the above-described processing.

Next, when determining that a failure is likely to occur in the current traveling area (step S122: YES), the failure information generation unit 150 generates failure information indicating the possibility that a failure occurs in the current traveling area (step S123).

Further, the failure information generation unit 150 may further divide each area into a plurality of zones, and specify zones where a failure is likely to occur, based on the current position included in the traveling information. Further, the failure information generation unit 150 may specify the current position included in the traveling information as a failure point where a failure is likely to occur. In this case, the failure information generation unit may include in the failure information, a zone or a failure point (latitude, longitude) where a failure is likely to occur.

Next, the message transmission unit 101 designates the current traveling area as a topic, and transmits the topic and the message including the failure information in association with each other to the broker 20 (step S124).

In this way, the on-board unit 10 repeatedly executes the processing of steps S121 to S124.

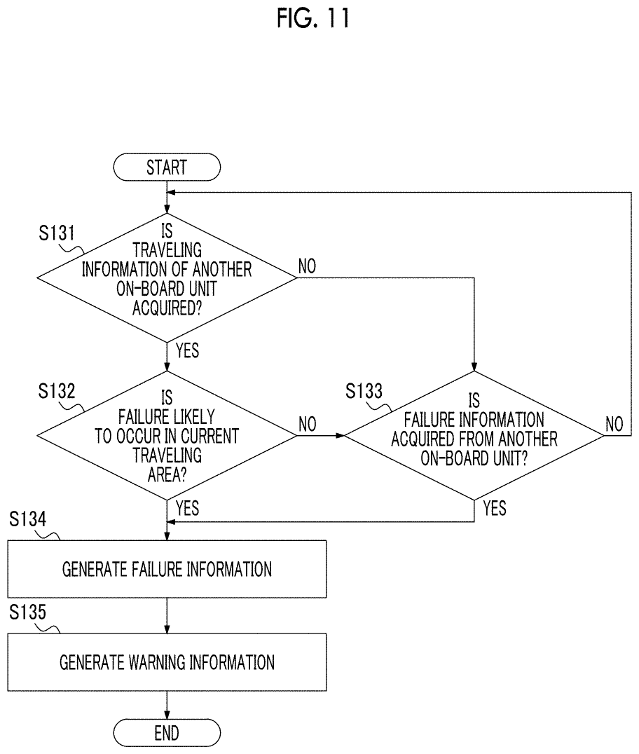

FIG. 11 is a second processing flow of the on-board unit according to the second embodiment of the present invention.

Hereinafter, with reference to FIG. 5 and FIG. 11, a process in which the on-board unit 10 issues a failure occurrence warning based on failure information will be described.

First, the failure information generation unit 150 determines whether or not a message including traveling information of the other on-board unit 10 has been acquired through the broker 20 (step S131).

When acquiring the message including the traveling information of the other on-board unit 10 (step S131: YES), the failure information generation unit 150 proceeds to the next step S132. On the other hand, when not acquiring the message including the traveling information of the other on-board unit 10 (step S131: NO), the process proceeds to step S133.

Next, when acquiring the message including the traveling information of the other on-board unit 10 (step S131: YES), the failure information generation unit 150 specifies the current traveling area of the other on-board unit 10 from the topic associated with the message including the acquired traveling information and determines whether a failure is likely to occur in the current traveling area of the other on-board unit 10 (step S132).

For example, as shown in FIG. 5, it is assumed that the failure information generation unit 150 of the on-board unit 10a acquires a message associated with a topic indicating the road X and including traveling information of the other on-board unit 10b. The failure information generation unit 150 of the on-board unit 10a determines whether a failure requiring operations such as a sudden braking or a sudden steering wheel operation or a failure such as a congestion is likely to occur, based on the current position, moving speed, acceleration, and traveling direction of the other on-board unit 10b included in the traveling information. Specifically, when the acceleration (the acceleration of the vehicle A2 in the traveling direction) included in the traveling information of the on-board unit 10b is lower than the reference value, the failure information generation unit 150 of the on-board unit 10a determines that a failure requiring a sudden braking is likely to occur in the current position of the vehicle A2. Further, for example, when the traveling direction included in the traveling information of the on-board unit 10b indicates a direction different from the extending direction of the road X where the vehicle A2 is located, or when the acceleration (acceleration corresponding to the turning motion) exceeds the reference value, the failure information generation unit 150 of the on-board unit 10a determines that a failure requiring a sudden steering wheel operation is likely to occur in the current position of the vehicle A2. Further, for example, when the moving speed included in the traveling information of the on-board unit 10b is less than the predetermined congestion determining speed, the failure information generation unit 150 of the on-board unit 10a determines that a failure such as congestion is likely to occur in the current position of the vehicle A2.

In this way, when the failure information generation unit 150 of the on-board unit 10a determines that a failure is likely to occur on the road X, based on the traveling information of the on-board unit 10b (step S132: YES), the process proceeds to step S134.

On the other hand, when the failure information generation unit 150 of the on-board unit 10a determines that a failure is not likely to occur on the road X, based on the traveling information of the other on-board unit 10b (step S132: NO), the process proceeds to step S133.

Next, the failure information generation unit 150 determines whether or not a message including failure information of the other on-board unit 10 has been acquired through the broker 20 (step S133).

When acquiring a message including failure information of the other on-board unit 10 (step S133: YES), the failure information generation unit 150 specifies the travel target area indicated by the topic of the message, and determines that a failure is likely to occur in the travel target area, and the process proceeds to step S134.

On the other hand, when not acquiring a message including failure information of the other on-board unit 10 (step S133: NO), the process returns to step S131 to repeat the above-described process.

Next, when it is determined that there is a possibility that a failure has occurred in the current traveling area of the other on-board unit 10 (step S132: YES or step S133: YES), the failure information generation unit 150 generates failure information indicating the possibility that a failure has occurred in the current traveling area of the other on-board unit 10 (step S134).

Further, the failure information generation unit 150 may further divide each area into a plurality of zones, and specify zones where a failure is likely to occur, based on the current position included in the traveling information of the other on-board unit 10. Further, the failure information generation unit 150 may specify the current position included in the traveling information of the other on-board unit 10 as a failure point where a failure may occur. In this case, the failure information generation unit may include in the failure information, a zone or a failure point (latitude, longitude) where a failure is likely to occur.

Further, the message transmission unit 101 may transmit to the broker 20, the failure information generated by the failure information generation unit 150 based on the traveling information of the other on-board unit 10.

Next, when the failure information generation unit 150 generates failure information, the warning information generation unit 132 generates warning information (second warning information) indicating that a failure is likely to occur in the travel target area (the current traveling area or the travel scheduled area), based on the failure information (step S135). Then, the warning information generation unit 132 outputs the generated warning information to the notification unit 140 as guidance information. By outputting the guidance information, the notification unit 140 makes a notification and issue a warning to the driver or the like of the on-board unit 10 that a failure is likely to occur in the travel target area.

In this way, the on-board unit 10 repeatedly executes the processing of the above-described steps S131 to S135.

Note that the processing flow of FIG. 11 is an example, and the order of processing and the like may be changed. For example, the failure information generation unit 150 may execute step S133 first, or step S131 and step S133 in parallel.

### Function and Effect

As described above, the on-board unit 10 according to the present embodiment further includes the failure information generation unit 150 that generates failure information indicating that a failure is likely to occur in the travel target area, based on at least one of the traveling information generated by the traveling information generation unit 120 and the traveling information of the other on-board unit 10 included in the message delivered from the broker 20.

Further, when the failure information generation unit 150 generates failure information, the message transmission unit 101 designates a topic indicating the travel target area where a failure is likely to occur, and transmits to the broker 20, the topic and a message including the failure information in association with each other.

Since the server 30 cannot generate highly accurate traffic information unless a lot of pieces of traveling information are collected from the on-board unit 10, there is a possibility that the frequency of updating the traffic information becomes low. However, since the on-board unit 10 according to the present embodiment has the above-described configuration, the failure information generation unit 150 can detect the occurrence of a failure in the travel target area, based on the traveling information generated by the traveling information generation unit 120. Further, the failure information generation unit 150 transmits the message including the failure information to the broker 20 through the message transmission unit 101, thereby notifying the other on-board unit 10 that a failure is likely to occur. Therefore, even in a situation where the server 30 less frequently updates traffic information, and traffic information cannot be acquired for a long period of time, the on-board unit 10 can detect in real time that a failure occurs in the travel target area, based on the failure information acquired from the other on-board unit 10.

Further, the warning information generation unit 132 generates as the guidance information, warning information (second warning information) indicating that a failure occurs in the travel target area, based on the failure information generated by the failure information generation unit 150. Then, the warning information generation unit 132 notifies the driver or the like of the on-board unit 10 of the generated warning information through the notification unit 140 to warn.

With such a configuration, the warning information generation unit 132 can generate in real time warning information (second warning information) indicating that a failure is likely to occur in the travel target area, based on the failure information generated by the failure information generation unit 150, even in a situation where the server 30 less frequently updates traffic information, and traffic information cannot be acquired for a long period of time. Further, the warning information generation unit 132 notifies the driver or the like of the vehicle A of the generated warning information through the notification unit 140 to alert the driver or the like of the vehicle A before the vehicle A reaches an area where a failure is likely to occur, so it is possible to reduce a risk of collision of the vehicle A with an obstacle, another vehicle A, or the like.

In addition, in the above-described example, an aspect in which the failure information generation unit 150 of the on-board unit 10a generates the failure information based on the traveling information of one on-board unit (on-board unit 10b) has been described, but the present invention is not limited to thereto. The failure information generation unit 150 of the on-board unit 10a may generate the failure information, based on the traveling information of each of a plurality of other on-board units 10b, 10c, . . . . In this case, for example, the failure information generation unit 150 may determine that a failure occurs on the road X, when the number of other on-board units 10b, 10c, . . . that are determined to abnormally travel on the road X is equal to or more than a predetermined number (for example, five). In this way, the failure information generation unit 150 can improve the accuracy of determination as to whether or not a failure occurs.

When acquiring a message including failure information from a plurality of on-board units 10 in a certain area through the broker 20 within a predetermined collection period, the dangerous area information generation unit 312 of the server 30 may generate dangerous area information, based on the failure information. In this case, the abnormal travel detection unit 311 may be omitted. Thus, the configuration and processing of the traffic information generation unit 310 of the server 30 can be simplified.

### Third Embodiment

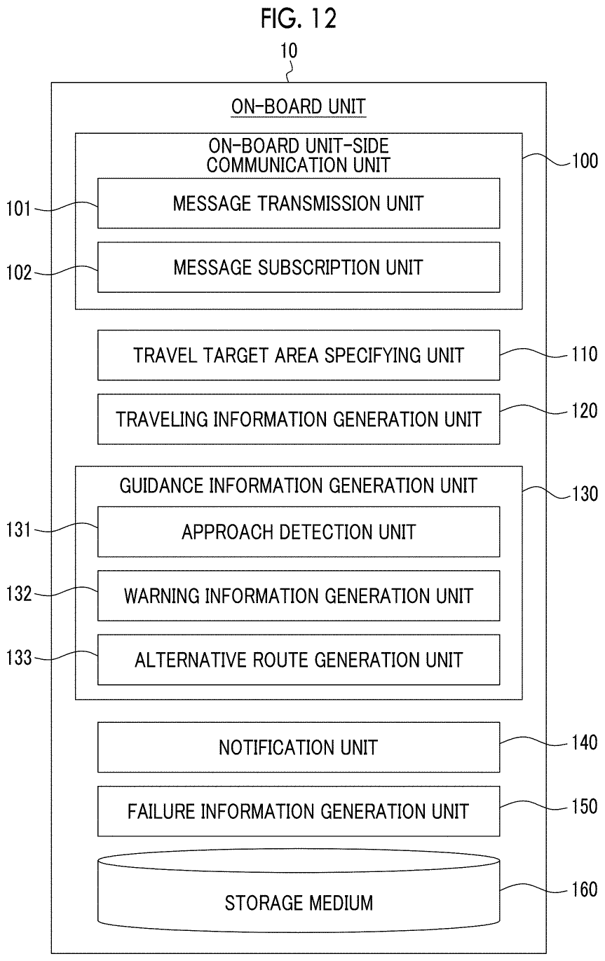

Hereinafter, a communication system 1 according to a third embodiment of the present invention will be described with reference to FIGS. 12 to 15.

Constituent elements common to those of the first and second embodiments are denoted by the same reference numerals, and a detailed description thereof is omitted.

### Functional Configuration of Vehicle-Mounted Device

FIG. 12 is a diagram illustrating a functional configuration of an on-board unit according to a third embodiment of the present invention.

As shown in FIG. 12, the on-board unit 10 according to the present embodiment is different from the first and second embodiments in that the guidance information generation unit 130 further includes an alternative route generation unit 133.

An aspect has been described in which the failure information generation unit 150 according to the second embodiment generates failure information indicating that a failure has occurred in the travel target area, based on at least one of the traveling information generated by the traveling information generation unit 120 and the traveling information of another on-board unit 10 included in the message delivered from the broker 20. However, the failure information generation unit 150 of the present embodiment is different from the above-described embodiment in that it acquires a message including the dangerous area information generated by the dangerous area information generation unit 312 of the server 30 or the congestion information (described later) generated by the congestion information generation unit 313 of the server 30 through the broker 20, and further generates failure information, based on the dangerous area information or the congestion information.

The alternative route generation unit 133 generates an alternative route including a point different from the point at which the vehicle is scheduled to travel, as guidance information, based on at least one of messages including the failure information generated by the other on-board unit 10, the dangerous area information generated by the dangerous area information generation unit 312 of the server 30, and the congestion information (described later) generated by the congestion information generation unit 313 of the server 30, among messages associated with the topic indicating the travel target area delivered from the broker 20.

### Functional Configuration of Server

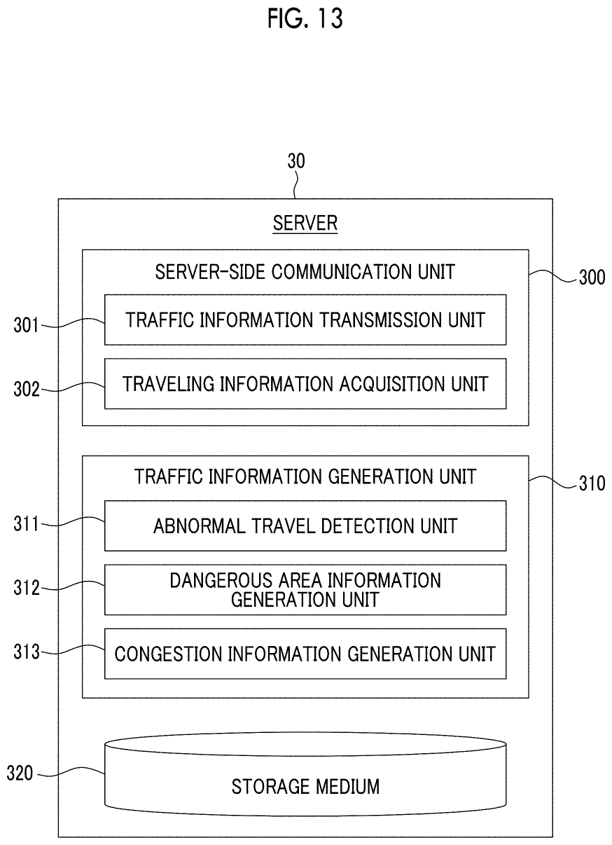

FIG. 13 is a diagram illustrating a functional configuration of the server according to the third embodiment of the present invention.

As shown in FIG. 13, the server 30 according to the present embodiment is different from the first and second embodiments in that the traffic information generation unit 310 further includes a congestion information generation unit 313.

The congestion information generation unit 313 determines whether or not congestion has occurred in each area, based on a message including traveling information generated by the traveling information generation unit 120 of the on-board unit 10, among the messages delivered from the broker 20. Specifically, the congestion information generation unit 313 analyzes the plurality of pieces of traveling information acquired in a predetermined collection period (for example, one hour) for each area, and calculates the average moving speed by area from the moving speed included in the traveling information. When the average moving speed of a certain area is less than the congestion determining speed, the congestion information generation unit 313 determines that congestion occurs in the area.

When determining that congestion occurs in a certain area, the congestion information generation unit 313 generates congestion information of the area.

In addition, the congestion information generation unit 313 designates a topic associated with the area where the congestion occurs, and transmits a message including the generated congestion information to the broker 20 by the traffic information transmission unit 301.

### Processing Flow of Vehicle-Mounted Device

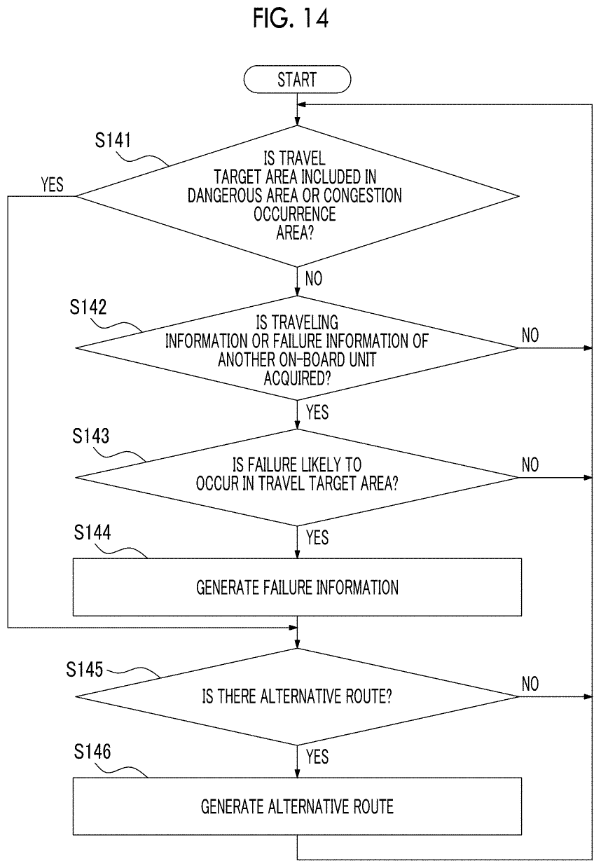

FIG. 14 is a processing flow of the on-board unit according to the third embodiment of the present invention.

Hereinafter, a process of generating the alternative route by the on-board unit 10 will be described.

First, based on a message including dangerous area information or congestion information delivered from the broker 20, the failure information generation unit 150 determines whether or not the travel target area is included in at least one of the dangerous area and the area where congestion has occurred (step S141).

For example, when acquiring the dangerous area information indicating that at least one of the travel target areas is a dangerous area, the failure information generation unit 150 determines that the travel target area is included in the dangerous area (step S141: YES). In addition, when acquiring a message including congestion information, which is associated with a topic indicating at least one area (for example, road X) in the traveling target areas, the failure information generation unit 150 determines that the area (road X) is included in the congestion occurrence area where congestion occurs (step S141: YES). When determining that at least one of the travel target areas is included in at least one of the dangerous area and the congestion occurrence area, the failure information generation unit 150 proceeds to step S145.

On the other hand, when determining that neither of the travel target areas is included in the dangerous area or the congestion occurrence area (step S141: NO), the failure information generation unit 150 proceeds to step S142.

Next, when determining that none of the travel target areas is included in the dangerous area or the area where congestion has occurred (step S141: NO), the failure information generation unit 150 determines whether or not a message including the traveling information or failure information of the other on-board unit 10 has been acquired through the broker 20 (step S142).

When acquiring the message including the traveling information or failure information of the other on-board unit 10 (step S142: YES), the failure information generation unit 150 proceeds to the next step S143. On the other hand, when not acquiring a message including traveling information of the other on-board unit 10 (step S142: NO), the process returns to step S141 to repeat the above-described process.

Next, when acquiring the message including the traveling information or the failure information of the other on-board unit 10 (step S142: YES), the failure information generation unit 150 determines whether or not a failure is likely to occur in the travel target area, based on the acquired traveling information or failure information (step S143).

The process of determining whether or not a failure is likely to occur, based on the traveling information or the failure information of the other on-board unit 10 by the failure information generation unit 150 is the same as the process of steps S132 and S133 of the second embodiment (FIG. 11).

When determining that a failure is likely to occur in the travel target area (step S143: YES), the failure information generation unit 150 proceeds to step S144.

On the other hand, when determining that a failure is not likely to occur in the travel target area (step S143: NO), the failure information generation unit 150 returns to step S141 and repeats the above-described processing.

Next, when determining that a failure is likely to occur in the travel target area, based on the traveling information or the failure information of the other on-board unit 10 (YES in step S143), the failure information generation unit 150 generates failure information indicating that a failure is likely to occur in the travel target area (step S144). In addition, when it is determined that failures are likely to occur in a plurality of travel target areas, the failure information generation unit 150 may generate a plurality of pieces of failure information for travel target areas, respectively.

Next, the alternative route generation unit 133 determines whether or not there is an alternative route avoiding at least one of a dangerous area, a congestion occurrence area, and an area where a failure is likely to occur, based on at least one of the dangerous area information, the congestion information, and the failure information (step S145).

Specifically, when at least one of the travel target areas is included in at least one of the dangerous area and the congestion occurrence area (step S141: YES), the alternative route generation unit 133 sets an area included in at least one of the dangerous area and the congestion occurrence area as an avoidance target area. When the plurality of travel target areas are included in at least one of the dangerous area and the congestion occurrence area, the alternative route generation unit 133 may set a plurality of avoidance target areas.

In addition, the alternative route generation unit 133 sets an area in which a failure is likely to occur, as the avoidance target area, based on the failure information generated by the failure information generation unit 150. When the failure information generation unit 150 generates a plurality of pieces of failure information, that is, a failure occurs in a plurality of areas, the alternative route generation unit 133 may set a plurality of avoidance target areas.

Then, the alternative route generation unit 133 determines whether there is an alternative route to avoid the avoidance target area (the avoidance target area is not used). When a plurality of avoidance target areas are set, the alternative route generation unit 133 determines whether there is an alternative route to avoid at least one avoidance target area.

For example, when the failure information generation unit 150 determines that a failure occurs on the road X, based on the dangerous area information, the alternative route generation unit 133 searches for alternative routes to avoid the road X, including other roads different from the road X, among the roads (points) included in the travel scheduled area. When the alternative route avoiding the road X can be searched (step S145: YES), the alternative route generation unit 133 proceeds to the next step S146.

On the other hand, when the alternative route avoiding the road X cannot be searched (step S145: NO), the alternative route generation unit 133 returns to step S141 and repeats the above process. In addition, when the alternative route generation unit 133 cannot search for an alternative route to avoid the road X, the warning information generation unit 132 may generate warning information indicating that a failure has occurred on the road X, and make notification of the warning information through the notification unit 140. The process of generating and making notification of warning information is the same as the process of step S135 in the second embodiment (FIG. 11).

Next, when the alternative route avoiding the travel target area (road X) where the failure occurs can be searched (step S145: YES), the alternative route generation unit 133 generates the alternative route as guidance information (step S146). Further, the alternative route generation unit 133 presents the generated alternative route to the driver or the like of the vehicle A through the notification unit 140 so as to urge the driver to travel while avoiding the area where the obstacle has occurred.

In this way, the on-board unit 10 repeatedly executes the processing of the above-described steps S141 to S146.

### Processing Flow of Server

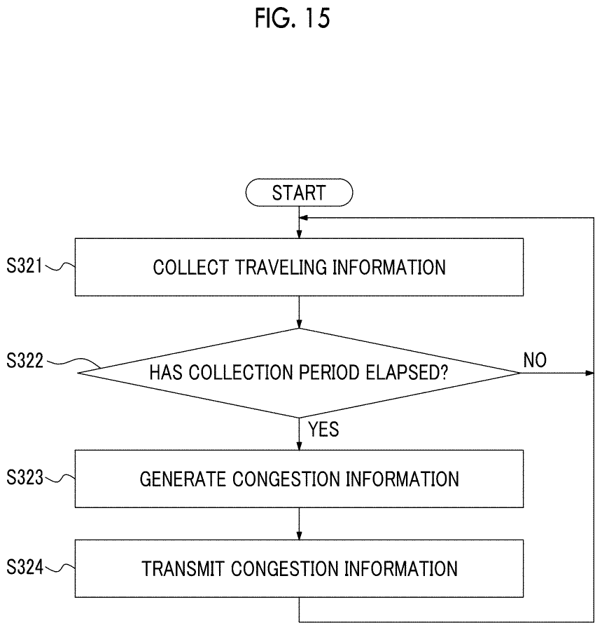

FIG. 15 is a processing flow of the server according to the third embodiment of the present invention.

Hereinafter, a process of generating congestion information by the server 30 will be described.

First, the traveling information acquisition unit 302 designates a topic indicating “all areas”, and requests the broker 20 to subscribe messages related to each area. Then, the traveling information acquisition unit 302 collects traveling information of the on-board unit 10 in each area, based on the message delivered from the broker 20 and the topic associated with the message (step S321).

Next, the congestion information generation unit 313 determines whether or not a predetermined collection period (for example, one hour) has elapsed (step S322).

When the collection period has not elapsed (step S322: NO), the congestion information generation unit 313 waits until the collection period has elapsed. Meanwhile, the server 30 returns to step S321 and repeats the above-described process.

On the other hand, when the collection period has elapsed (step S322: YES), the congestion information generation unit 313 proceeds to the next step S323.

Next, the congestion information generation unit 313 generates congestion information for each area, based on the traveling information collected in step S321 (step S323).

For example, the congestion information generation unit 313 acquires a plurality of pieces of traveling information of the on-board unit 10 associated with the road X, and calculates the average moving speed from the moving speed included in each traveling information. When the average moving speed is less than the congestion determining speed, the congestion information generation unit 313 determines that congestion occurs in the road X, and generates congestion information.

Further, in the map information stored in the storage medium 320, the congestion determining speed is set in advance for each road based on the limit speed or the like. Further, a plurality of congestion determining speeds may be set for each road to determine the degree of congestion (heavy congestion, little congestion, or the like). For example, in a case where the first congestion determining speed of the road X is 40 km/h and the second congestion determining speed is 20 km/h, the congestion information generation unit 313 may make a determination as “little congestion” when the average moving speed is less than the first congestion determining speed, and “heavy congestion” when it is less than the second congestion determining speed.

In addition, the congestion information generation unit 313 may generate congestion information linking the area where congestion occurs with the degree of congestion. Further, the congestion information generation unit 313 may further divide each area into a plurality of zones and determine the degree of congestion for each area. In this case, the congestion information generation unit 313 may generate congestion information linking the area where congestion occurs with the degree of congestion in each zone.

When generating congestion information for each area, the congestion information generation unit 313 proceeds to the next step S324.

Next, the congestion information generation unit 313 designates a topic indicating an area where congestion has occurred, and transmits the topic and a message including the generated congestion information in association with each other, through the traffic information transmission unit 301 to the broker 20 (step S324).

In this way, the server 30 repeatedly executes the processing of the above-described steps S321 to S324.

### Function and Effect

As described above, in the communication system 1 according to the present embodiment, the congestion information generation unit 313 of the server 30 generates congestion information for each area as the traffic information, based on the traveling information acquired from the on-board unit 10 through the broker 20.

Further, the alternative route generation unit 133 of the on-board unit 10 generates as guidance information, a traveling route including a point different from a point at which the vehicle is scheduled to travel, based on at least one of the failure information, the dangerous area information, and the congestion information.

With such a configuration, the alternative route generation unit 133 can generate an alternative route, based on the traffic information (dangerous area information or congestion information) generated by the server 30, and even in a state where the server 30 less frequently updates the dangerous area information or the congestion information, and a message including the dangerous area information or the congestion information is not delivered for a long period of time, can generate the failure information, based on the traveling information acquired from another on-board unit 10, and generate an alternative route to failure, based on the failure information.

In addition, in the present embodiment, an aspect in which the congestion information generation unit 313 of the server 30 generates congestion information for each area, based on the message including the traveling information of the on-board unit 10 has been described, but the present invention is not limited to thereto. For example, the congestion information generation unit 313 may generate congestion information, based on a message including failure information generated by the failure information generation unit 150 of the on-board unit 10. In this case, the traveling information acquisition unit 302 further requests the broker 20 to subscribe to the message including the failure information generated by the failure information generation unit 150 of the on-board unit 10.

In this way, by generating congestion information, based on the failure information generated by the on-board unit 10, it is possible to simplify the processing in the congestion information generation unit 313.

### Hardware Configuration of Vehicle-Mounted Device

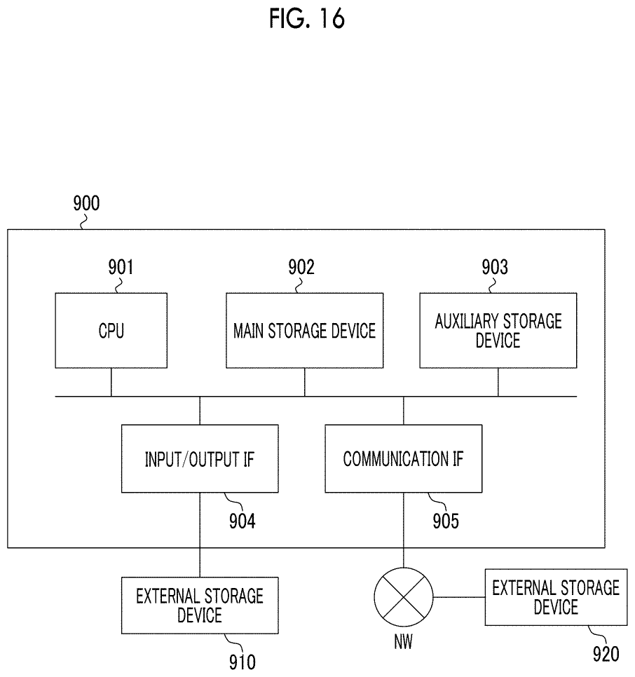

FIG. 16 shows the hardware configuration of the on-board unit according to each embodiment of the present invention.

Hereinafter, with reference to FIG. 16, a hardware configuration of the on-board unit 10 according to each of the above-described embodiments will be described.

A computer 900 includes a CPU 901, a main storage device 902, an auxiliary storage device 903, an input/output interface 904, and a communication interface 905.

The above-described on-board unit 10 is mounted on the computer 900. The operations of the respective processing units of the above-described on-board unit 10 are stored in the auxiliary storage device 903 of each computer 900 in the form of a program. The CPU 901 reads the program from the auxiliary storage device 903, develops the program into the main storage device 902, and executes the above process according to the program. The CPU 901 of the on-board unit 10 secures a storage area corresponding to the storage medium 160 in the main storage device 902 in accordance with the program. The CPU 901 secures a storage area for storing data under processing in the auxiliary storage device 903 in accordance with the program. Further, the computer 900 is connected to the external storage device 910 through the input and output interface 904, and the storage area corresponding to the storage medium 160 of the on-board unit 10 may be secured in the external storage device 910. Further, the computer 900 is connected to the external storage device 920 through the communication interface 905, and the storage area corresponding to the storage medium 160 of the on-board unit 10 may be secured in the external storage device 920.

In at least one embodiment, the auxiliary storage device 903 is an example of a non-transitory tangible medium. Other examples of non-transitory tangible medium include magnetic disks, magneto-optical disks, CD-ROMs, DVD-ROMs, semiconductor memories, and the like connected through the input and output interface 904. Further, when this program is delivered to the computer 900 through a communication line, the computer 900 receiving the delivery may develop the program in the main storage device 902 and execute the above process.

Further, the program may be used to realize a part of the above-described functions. Further, the program may be a so-called differential file (differential program) which realizes the above-described function in combination with other programs already stored in the auxiliary storage device 903.

Although the embodiment of the present invention has been described in detail above, the present invention is not limited to these as long as it does not deviate from the technical idea of the present invention, and some design change and the like are also possible.

For example, in the above-described embodiment, an aspect in which the communication system 1 includes one server 30, but the present invention is not limited thereto. In another embodiment, the communication system 1 may include a plurality of servers.

In addition, the plurality of servers may have the respective functional units of the server 30 in the above-described embodiment in a dispersed manner.

### INDUSTRIAL APPLICABILITY

According to the communication system, the on-board unit, and the communication method, described above, it is possible to perform communication between an on-board unit and a server and between on-board units, using a common communication method.

1. A communication system comprising:
an on-board unit that is mounted on a vehicle;
a server that generates traffic information; and
a broker that mediates communication between a plurality of the on-board units and between the on-board unit and the server,
wherein the on-board unit includes
a travel target area specifying unit that specifies a travel target area including at least one of a point at which the vehicle is traveling and a point at which the vehicle is scheduled to travel, among a plurality of areas obtained by dividing map into predetermined ranges;
a traveling information generation unit that generates traveling information including the point at which the vehicle is traveling;
a message transmission unit that among a plurality of topics prepared in advance for each of the plurality of areas, designates a topic indicating the travel target area, and transmits to the broker, the designated topic and a message including the traveling information in association with each other;
a message subscription unit that designates a topic indicating the travel target area and requests the broker to subscribe to a message associated with the topic; and
a guidance information generation unit that generates guidance information in the travel target area, based on a message delivered from the broker,
wherein the server includes
a traveling information acquisition unit that requests the broker to subscribe to a message including the traveling information of the on-board unit;
a traffic information generation unit that generates traffic information for each area, based on the traveling information; and
a traffic information transmission unit that transmits to the broker, a message including the traffic information, and
wherein the broker includes
a message delivery unit that delivers a message received from the on-board unit and the server to the on-board unit and the server that designate a topic associated with the message and request subscription.

2. The communication system according to claim 1,
wherein the traffic information generation unit of the server generates, as the traffic information, dangerous area information indicating a dangerous area which is predicted to have a risk of collision of the vehicle, based on the traveling information, and
wherein when the travel target area is included in the dangerous area,
the message subscription unit of the on-board unit designates a topic indicating the travel target area included in the dangerous area and requests the broker to subscribe to a message associated with the topic,
the guidance information generation unit of the on-board unit generates, as the guidance information, first warning information indicating that a host vehicle is approaching the dangerous area, and
the message transmission unit designates a topic indicating the travel target area, and transmits to the broker, the designated topic and a message including the first warning information in association with each other.

3. The communication system according to claim 2,
wherein the on-board unit further includes a failure information generation unit that generates failure information indicating that a failure is likely to occur in the travel target area, based on at least one of the traveling information generated by the traveling information generation unit and the traveling information of another on-board unit, and
wherein the message transmission unit of the on-board unit designates a topic indicating the travel target area where the failure is likely to occur, and transmits to the broker, the topic and a message including the failure information in association with each other.

4. The communication system according to claim 3,
wherein the guidance information generation unit of the on-board unit generates as the guidance information, second warning information indicating that a failure is likely to occur in the travel target area, based on the failure information generated by the failure information generation unit.

5. The communication system according to claim 3,
wherein the traffic information generation unit of the server generates congestion information for each area as the traffic information, based on the traveling information, and
wherein the guidance information generation unit of the on-board unit generates an alternative route including a point different from a point at which the vehicle is scheduled to travel as the guidance information, based on at least one of the failure information, the dangerous area information, and the congestion information.

6. A on-board unit that is mounted on a vehicle, comprising:
a travel target area specifying unit that specifies a travel target area including at least one of a point at which the vehicle is traveling and a point at which the vehicle is scheduled to travel, among a plurality of areas obtained by dividing map into predetermined ranges;
a traveling information generation unit that generates traveling information including the point at which the vehicle is traveling;
a message transmission unit that among a plurality of topics prepared in advance for each of the plurality of areas, designates a topic indicating the travel target area, and transmits the designated topic and a message including the traveling information in association with each other, to a broker which mediates communication between the server and another on-board unit;
a message subscription unit that designates a topic indicating the travel target area and requests the broker to subscribe to a message associated with the topic; and
a guidance information generation unit that generates guidance information in the travel target area, based on a message delivered from the broker.

7. A communication method using an on-board unit that is mounted on a vehicle, a server that generates traffic information, and a broker that mediates communication between a plurality of the on-board units and between the on-board unit and the server, the communication method comprising:
a travel target area specifying step of specifying a travel target area including at least one of a point at which the vehicle is traveling and a point at which the vehicle is scheduled to travel, among a plurality of areas obtained by dividing map into predetermined ranges, by the on-board unit;
a traveling information generation step of generating traveling information including the point at which the vehicle is traveling, by the on-board unit;
a message transmission step of, among a plurality of topics prepared in advance for each of the plurality of areas, designating a topic indicating the travel target area, and transmitting to the broker, the designated topic and a message including the traveling information in association with each other, by the on-board unit;
a message subscription step of designating a topic indicating the travel target area and requesting the broker to subscribe to a message associated with the topic, by the on-board unit;
a guidance information generation step of generating guidance information in the travel target area, based on a message delivered from the broker, by the on-board unit;
a traveling information acquisition step of requesting the broker to subscribe to a message including the traveling information of the on-board unit, by the server;
a traffic information generation step of generating traffic information for each area, based on the traveling information, by the server;
a traffic information transmission step of transmitting to the broker, a message including the traffic information, by the server; and
a message delivery step of delivering a message received from the on-board unit and the server to the on-board unit and the server that designate a topic associated with the message and request subscription, by the broker.

8. The communication system according to claim 4,
wherein the traffic information generation unit of the server generates congestion information for each area as the traffic information, based on the traveling information, and
wherein the guidance information generation unit of the on-board unit generates an alternative route including a point different from a point at which the vehicle is scheduled to travel as the guidance information, based on at least one of the failure information, the dangerous area information, and the congestion information.
